(19) United States
(12) Patent Application Publication
(10) Pub. No.: US 2005/0210525 A1
(43) Pub. Date: Sep. 22, 2005

(54) Method and apparatus for maintaining state information

(75) Inventors: Kevin T. Carle, Mountain View, CA (US); Daniel J. Zigmond, Menlo Park, CA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/806,977

(22) Filed: Mar. 22, 2004

(51) Int. Cl. H04N 7/173; G06F 11/00; H04N 7/16

(52) U.S. Cl. 725/105; 725/131; 725/139; 725/151

(57) ABSTRACT

A method initializes a client device that has an associated identifier. The identifier is communicated to a configuration server that contains configuration information associated with the client device. The configuration information is received from the configuration server and is applied to the client device. Video data is also received from the configuration server.

### TECHNICAL FIELD

The systems and methods described herein relate to maintaining state information for a client device.

### BACKGROUND

A client device in a television-based system can receive video and audio content from a program distributor in the form of broadcast programs, such as news programs, sitcoms, movies, sporting events, commercials, and any other type of television-based information. A client device may also receive other types of data, such as data associated with a remote application. A client device includes, for example, a set-top box, a digital satellite receiver, a cable box, a digital video recorder (DVR), and a television with a built-in receiver.

Existing client devices store user settings, preferences, and account information. For example, a persistent memory device may be included in client devices to store settings, preferences, and other information. Adding a persistent memory device to a client device increases the cost and complexity of the client device.

Television broadcasting systems (such as cable TV broadcasters or satellite broadcasters) originate and communicate signals to customers from a headend (or “head-end”). The headend contains equipment to broadcast signals and provide other services to multiple customers. A headend interacts with each client device to provide content that is appropriate for the client device based on the settings, preferences and account information associated with the client device. This arrangement can cause a loss of data if the client device malfunctions. Loss of data usually requires re-configuration of the client device by the user. Additionally, if a particular household has multiple client devices (e.g., coupled to multiple televisions), each client device is typically configured separately from the other client devices. This separate configuration of each client device can be tedious, especially when each client device is configured in a similar manner.

### SUMMARY

The systems and methods described herein maintain configuration information for a client device in a remote location. In a particular embodiment, a client device having an associated identifier is initialized. The identifier associated with the client device is communicated to a configuration server that contains configuration information associated with the client device. The configuration information is received from the configuration server and is applied to the client device. Data, such as video data, is then received from the configuration server.

### BRIEF DESCRIPTION OF THE DRAWINGS

Similar reference numbers are used throughout the figures to reference like components and/or features.

FIG. 1 illustrates various components of an example architecture capable of providing content to one or more-client devices.

FIG. 2 is a flow diagram illustrating an embodiment of a procedure for configuring a client device.

FIG. 3 is a flow diagram illustrating an embodiment of a procedure for implementing task requests received by a client device.

FIG. 4 is a flow diagram illustrating an embodiment of a procedure for updating configuration information associated with a client device.

FIG. 5 illustrates example configuration information associated with a particular client device.

FIG. 6 illustrates an example client device and related devices that are associated with the client device.

### DETAILED DESCRIPTION

The systems and methods described herein store configuration information associated with a client device in a storage device, such as a server, associated with a headend system that provides content to the client device. By storing this configuration information remotely from the client device, the configuration information is not lost in the case of a client device malfunction. Additionally, the same configuration information can be downloaded into multiple client devices, thereby eliminating the need for users of multiple client devices to manually enter the same configuration information in each of the multiple client devices.

The systems and methods described herein also allow users or other systems to access the configuration information from the headend systems without requiring interaction with the client device with which the configuration information is associated. Additionally, by storing configuration information remotely, the remote system may customize data sent to the client device such that the customized data is limited to information that the client device can use. This customization of data reduces the amount of data that is sent to the client device as compared to systems that send large amounts of data to a client device, which filters out unnecessary data.

When utilizing the systems and methods discussed herein, the client device may have limited resources, such as no persistent memory, because the configuration information that needs to be persisted is stored remotely from the client device. By reducing resources in the client device, the cost and complexity of the client device is also reduced.

The systems and methods discussed herein are described with reference to an environment in which content is distributed to client devices via a data communication network, such as the Internet. These examples represent one possible environment in which the systems and methods can be implemented. In other embodiments, any type of system or architecture can be used to provide content to one or more client devices.

Client devices of the type discussed herein range from clients with substantial memory and processing resources, such as television-enabled personal computers and television recorders equipped with hard-disks, to clients with little or no memory and/or limited processing resources. Although particular examples of client devices are discussed herein, any client device can be used with the systems and methods described. Example client devices include personal computers, DVD players, digital video recorders (DVRs), set top boxes, cable boxes, satellite receivers, televisions, game consoles, and the like. As used herein, the term “user” may also be referred to as “viewer”. Also, as used herein, the terms “state information”, “configuration information”, and “configuration settings” are used interchangeably.

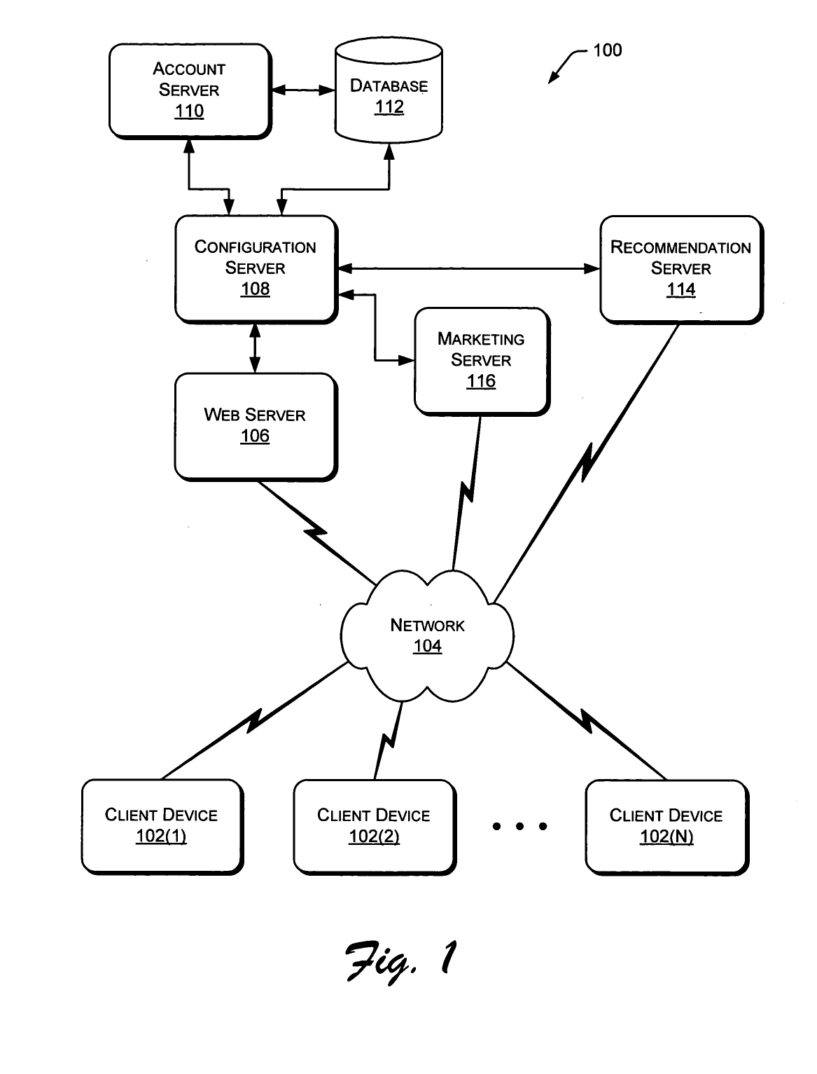

FIG. 1 illustrates various components of an example architecture 100 capable of providing content to one or more client devices 102. In this example architecture 100, content (such as television programs, video on demand, advertisements, and the like) is distributed via a data communication network 104, such as the Internet. Architecture 100 provides two-way communication of data between client devices and one or more servers via network 104. In alternate embodiments, content is distributed to client devices 102 via a cable network, radio frequency signals, over-the-air broadcast, satellite communication systems, and the like.

In a particular embodiment, client devices 102 communicate with one or more servers via network 104 using simple object access protocol (SOAP) messages transported using hypertext transfer protocol (http), a protocol commonly used by the World Wide Web. In other embodiments, any type of protocol and/or messaging format can be used to exchange data between client devices 102 and one or more servers.

Each client device 102 has a unique identifier stored within the client device. For example, the unique identifier may be stored in a non-volatile memory device or other component of the client device. Since each client device 102 has a unique identifier, each client device can be distinguished from the other client devices. Although not shown in FIG. 1, each client device 102 may be coupled to a display device (such as a television, computer monitor, or projector), a recording device (such as a VCR or DVR), or other device. Alternatively, one or more client devices 102 may themselves be televisions, recording devices, or other devices.

In the example of FIG. 1, network 104 may be any type of data communication network and may include two or more different networks, such as a local area network (LAN) and the Internet. A web server 106 is also coupled to network 104. In one embodiment, web server 106 is an Internet Information Server (IIS), available from Microsoft Corporation of Redmond, Wash. A configuration server 108 is coupled to web server 106 and functions to maintain configuration information related to client devices 102. As discussed below, configuration server 108 also receives requests for configuration information from client devices 102 and provides the requested configuration information to the client devices.

An account server 110 and a database 112 are coupled to configuration server 108. Account server 108 maintains information regarding customer accounts, customer subscriptions, customer billing histories, and the like. For example, account server 108 can maintain information regarding one or more client devices associated with a customer's account and payment status of the customer's account invoices. Database 112 stores various information used by configuration server 108, such as configuration information related to client devices 102. Database 112 may also store information used by account server 110, such as billing information and customer account information.

A recommendation server 114 is coupled to configuration server 108 and network 104. Recommendation server 114 generates, for example, television program recommendations for one or more client devices 102. A marketing server 116 is also coupled to configuration server 108 and network 104. Marketing server 116 generates, for example, advertisements and other marketing content that is provided to one or more client devices 102. The advertisements and other marketing content may be targeted to particular client devices 102 based on known viewing habits or preferences of the users of those particular client devices. Various other servers (not shown) may be coupled to configuration server 108 and network 104 to communicate with configuration server 108 and client devices 102. These other servers can request configuration information regarding client devices 102 from configuration server 108 and use that information to generate content, advertisements, and the like that are communicated to client devices 102.

Examples of other servers that may be coupled to configuration server 108 include a customer service server that accesses configuration information to allow a customer service agent to help a customer configure their client device and servers that run remote applications. Remote applications can, for example, generate user interface data that is provided to the client device, thereby allowing the client device to display a high-quality user interface without requiring the client device to have the resources necessary to generate the user interface.

Traditional television broadcasting systems (such as cable TV broadcasters or satellite broadcasters) originate and communicate signals to customers from a headend, as discussed above. In the architecture of FIG. 1, the headend may be considered as the equipment used to broadcast content and provide other services to multiple customers (e.g., via client devices 102). The headend interacts with each client device 102 to provide content that is appropriate for the client device based on the settings, preferences, and account information associated with the client device. Referring to FIG. 1, any one or more of the following devices may be considered as the “headend”: web server 106, configuration server 108, account server 110, database 112, recommendation server 114, and marketing server 116. In other embodiments, one or more additional devices may be considered part of the headend.

In the example of FIG. 1, configuration information associated with each client device 102 can be accessed via configuration server 108. Thus, rather than storing configuration information in each client device 102, the client devices retrieve necessary configuration information from configuration server 108, which retrieves the configuration information from database 112. This arrangement simplifies client device 102 by eliminating the need for the client device to have a storage device to store configuration information. Additionally, a client device can be relocated (e.g., to another household) or replaced without having to reconfigure the client device.

By providing persistent storage of client device configuration information on a remote device (e.g., configuration server/database), the configuration information is not lost if the client device malfunctions. Additionally, the storage reliability of the configuration information can be enhanced by providing redundant storage devices such as mirrored storage devices or tape backup systems. Multiple client devices can be configured to be identical to one another by associating the same configuration information with each client device. The architecture of FIG. 1 also allows servers or other devices to retrieve configuration information from the configuration server without requiring any interaction with the client device.

Although not shown in FIG. 1, architecture 100 may also include one or more additional servers coupled to network 104 or another component of FIG. 1. For example, a video content server may be coupled to network 104 and/or coupled to web server 106 to distribute video content (as well as audio content) to one or more client devices 102.

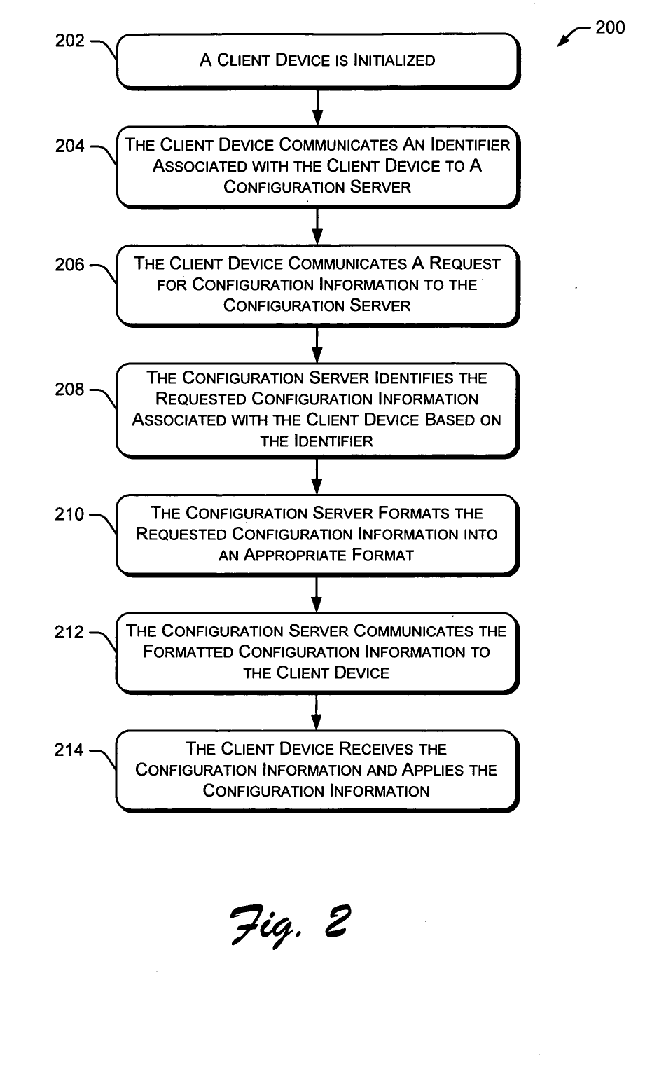

FIG. 2 is a flow diagram illustrating an embodiment of a procedure 200 for configuring a client device. Procedure 200 begins at block 202 where a client device is initialized (e.g., powered on or reset). The client device then communicates an identifier associated with the client to a configuration server (block 204). This identifier is, for example, a unique identifier that distinguishes the client device from other client devices having different identifiers. The client device also communicates a request for configuration information to the configuration server (block 206). For example, the requested configuration information may include the last channel received by the client device, favorite channel listings, parental control settings, language preferences, channel sorting order, and the like. The request for configuration information may request all available configuration information or may request specific configuration information (such as a last channel viewed). If specific configuration information is requested at initialization, additional configuration information can be requested at a later time when the configuration information is needed (e.g., when a user requests to view a favorite channel).

As procedure 200 continues, the configuration server identifies the requested configuration information associated with the client device based on the identifier provided by the client device (block 208). For example, the configuration server may retrieve the configuration information from an attached database or other storage mechanism. The configuration server then formats the requested configuration information into an appropriate format (block 210), such as an html format. Alternate embodiments may use other formats, such as serialized binary objects, plain text, and the like. Procedure 200 continues as the configuration server communicates the formatted configuration information to the client device (block 212). The client device receives the configuration information and applies the configuration information (block 214). For example, if the configuration information includes last channel information, the client device tunes to the last channel.

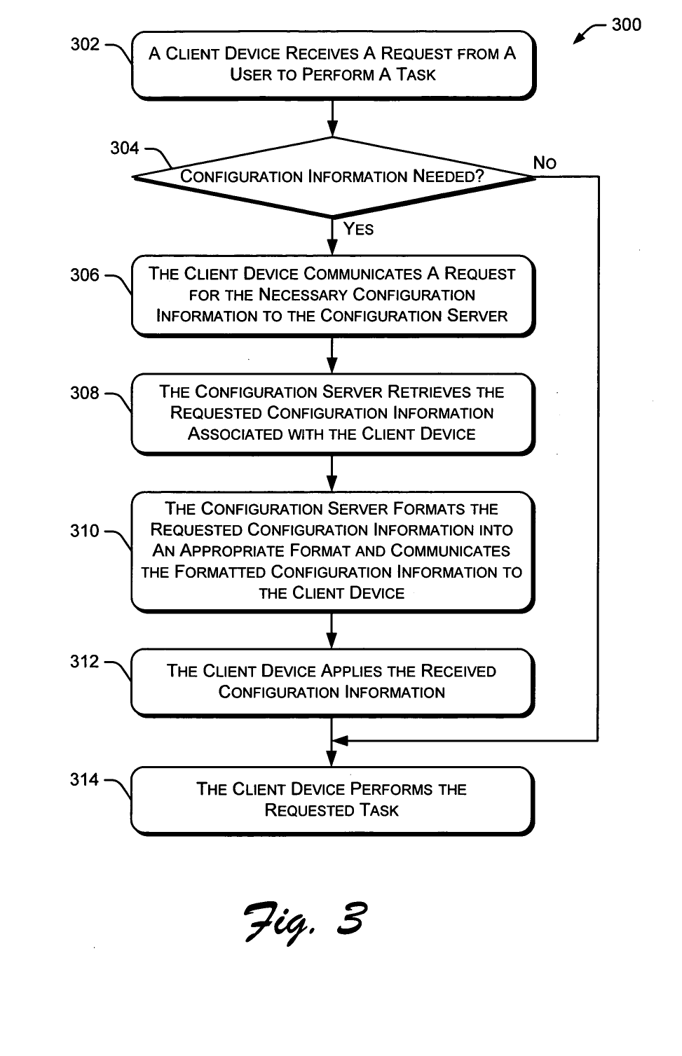

FIG. 3 is a flow diagram illustrating an embodiment of a procedure 300 for implementing task requests received by a client device. Initially, a client device receives a request from a user to perform a task (block 302). The task may include changing channels, displaying a program guide, displaying available video on demand (VOD) programs, or displaying a configuration menu. The client device then determines whether configuration information is needed to perform the task (block 304). For example, changing channels may not require additional configuration information, but displaying a program guide or displaying a list of favorite channels may require additional configuration information from the configuration server. If no additional configuration information is needed, the procedure branches to block 314 where the client device performs the requested task.

In another embodiment, block 304 may also determine whether the configuration information is already stored in the client device (e.g., from a previous request for the configuration information). If the configuration information is already stored in the client device, the client devices uses the stored configuration information. Otherwise, the client device continues to block 306 as discussed below.

If additional configuration information is needed, the procedure continues from block 304 to block 306 where the client device communicates a request for the necessary configuration information to the configuration server. In one implementation, each request specifies the identifier associated with the client device communicating the request. Alternatively, the identifier associated with the client device communicating the request could be sent over a session that has been established with a specific client, which implies the client's identifier.

The configuration server then retrieves the requested configuration information associated with the client device (block 308). Next, the configuration server formats the requested configuration information into an appropriate format and communicates the formatted configuration information to the client device (block 310). The client device receives the requested configuration information and applies the configuration information (block 312). Finally, the client device performs the task requested by the user of the client device (block 314).

After the task is completed, the requested configuration information may be discarded by the client device. If the client device needs the same configuration information in the future, the client device can request the same configuration information again. When operating in this manner, the client device always receives a current copy of the configuration information.

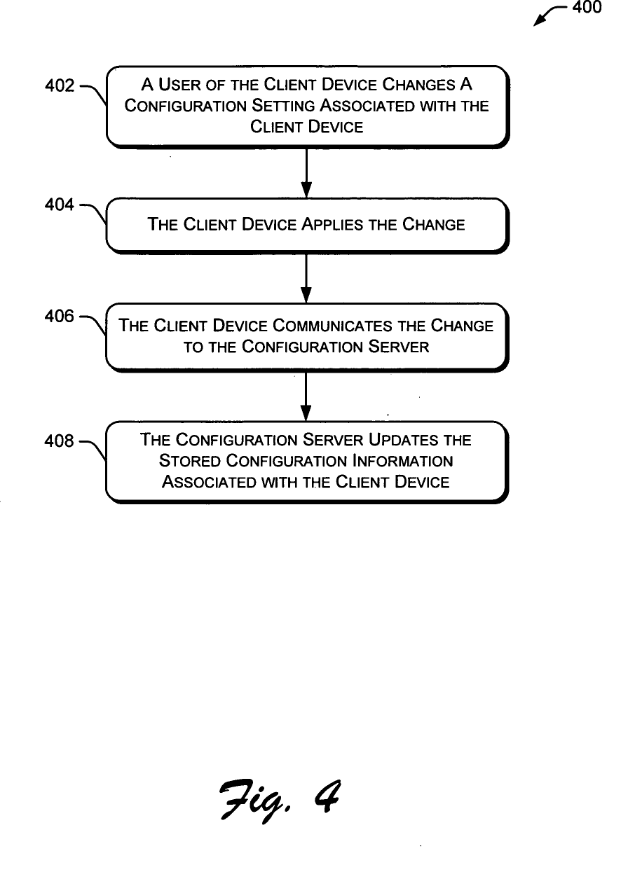

FIG. 4 is a flow diagram illustrating an embodiment of a procedure 400 for updating configuration information associated with a client device. Initially, a user of a client device changes a configuration setting associated with the client device (block 402). For example, the user of the client device may add a new favorite channel or change a parental control setting. The client device applies the change made by the user of the client device (block 404). The client device then communicates the change to the configuration server (block 406). The configuration server updates the stored configuration information associated with the client device based on the change made by the user of the client device (block 408). By updating the configuration information stored by the configuration server, the user's change will be applied to the client device during subsequent initializations of the client device.

In an alternate embodiment, the configuration information associated with one or more client devices is changed by a user interacting with the configuration server. For example, a user may access the configuration server via a Web browser application. The user then accesses a current version of the configuration information, makes any desired changes, and saves the modified configuration information on the configuration server. In one embodiment, these changes are communicated to the client device and applied by the client device as soon as they are entered by the user. In other embodiments, the updated configuration information is communicated to the client device after subsequent initializations of the client device.

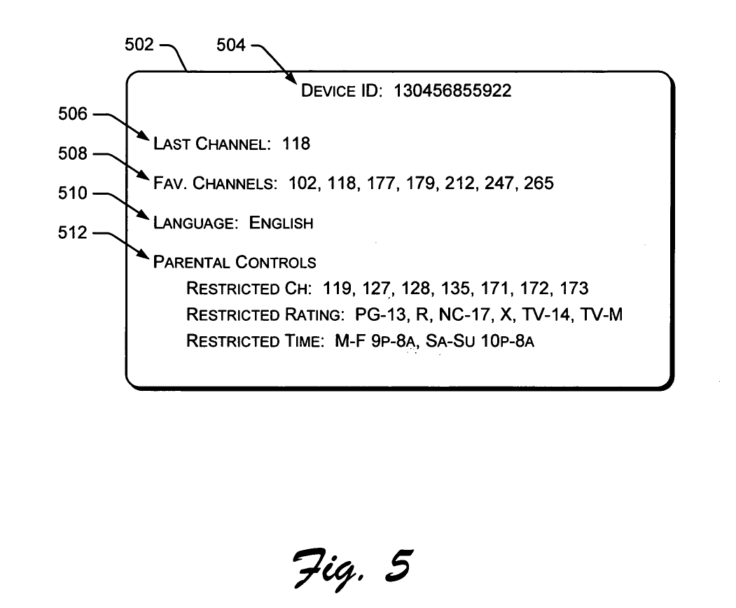

FIG. 5 illustrates example configuration information 502 associated with a particular client device. The configuration information shown in FIG. 5 may be associated with, for example, a particular database record. A device ID 504 is a unique identifier associated with the particular client device. Device ID 504 may contain any number of letters, numbers, or other characters or symbols. A last channel 506 indicates that the last channel tuned or otherwise displayed by the client device is channel 118. A favorite channel list 508 identifies channels 102, 118, 177, 179, 212, 247, and 265 as favorite channels associated with the client device. A language preference 510 indicates that English is the preferred language associated with the client device. Parental control settings 512 identify various restrictions based on channels, program ratings, and program times. For example, channels 119, 127, 128, 135, 171, 172, and 173 are not viewable on the client device. Additionally, any program rated PG-13, R, NC-17, X, TV-14, or TV-M is not viewable on the client device. The client device is also restricted with respect to time such that no program can be viewed between 9 pm and 8 am on weekdays and no program can be viewed between 10 pm and 8 am on weekends.

FIG. 5 illustrates one example of configuration information associated with a client device. In other embodiments, additional types of configuration information may be specified and/or certain configuration information shown in FIG. 5 may be omitted. The configuration information displayed in FIG. 5 may be stored in any format using any data structure, such as a table, database, or other structure.

In one embodiment, a household, business, or other organization may use multiple client devices of the type discussed herein. In this embodiment, there may be a single set of configuration information associated with the household that is applied to all client devices. Thus, a single set of configuration information is established and applied to all client devices. This set of configuration information may have an associated unique identifier.

Utilizing household configuration information eliminates the need to individually configure each of the client devices. Additionally, the household configuration information may be used as a default configuration for each client device, which can be overridden by configuration information associated with a particular client device. For example, the household configuration information may prohibit viewing of programs with a rating of PG-13 or higher. However, configuration information associated with a particular client device may override that prohibition by allowing the particular client device to display programs with any rating. In a particular embodiment, information regarding client devices associated with a common household is maintained by the account server.

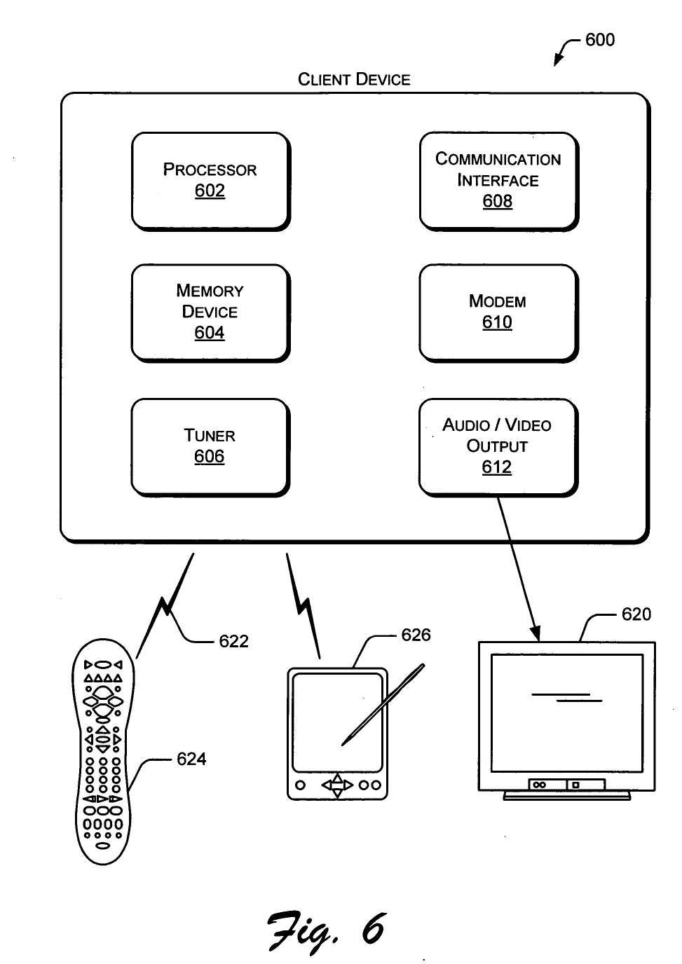

FIG. 6 illustrates an example client device 600 and related devices that are associated with the client device. Client device 600 includes a processor 602, an optional memory device 604, and a tuner 606. Processor 602 includes, for example, a microprocessor or controller, which processes various instructions to control the operation of client device 600 and to communicate with other devices. Memory device 604 is optional and may be implemented, for example, as a disk drive, a random access memory (RAM), a read-only memory (ROM), or a flash memory. Memory device 604 may store a unique identifier, configuration information, or other data. Tuner 606 may be an in-band tuner that tunes various frequencies or channels to receive television signals or an out-of-band tuner that tunes to the broadcast channel over which program data is broadcast to client device 600. Tuner 606 may include hardware-based tuners and/or digital tuners (e.g., software tuners) capable of “tuning” or identifying IP-based digital streams of data. IP-based digital streams serve a similar function as tuners, but are used in an IP environment for the delivery of content (e.g., the unicast delivery of content).

Client device 600 also includes a communication interface 608, a modem 610, and an audio/video output 612. Communication interface 608 can be implemented as a serial and/or parallel interface, as a wireless interface, and/or any other type of network interface. A wireless interface allows client device 600 to receive control input commands 622 and other information from a user-operated input device, such as from a remote control device 624 or from another infrared (IR), 0802.11, Bluetooth, or similar RF input device. Input devices can include a wireless keyboard or another handheld input device 626 such as a personal digital assistant (PDA), handheld computer, wireless phone, or the like. A network interface and a serial and/or parallel interface enables client device 600 to interact and communicate with other electronic and computing devices via various communication links. Modem 610 facilitates client device 600 communicating with other electronic and computing devices via a data communication network, a conventional telephone line, a DSL connection, a cable connection, and/or other type of connection.

Audio/video output 612 provides audio, video, and/or display signals to a television 620 or to other devices that process and/or display, or otherwise render, the audio and video data. Video signals and audio signals can be communicated from client device 600 to television 620 via an RF (radio frequency) link, S-video link, composite video link, component video link, or other similar communication link.

Although shown separately, some of the components of client device 600 may be implemented in an application specific integrated circuit (ASIC). Additionally, a system bus (not shown) may connect the various components within client device 600. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus (also known as a Mezzanine bus).

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
initializing a client device, wherein the client device has an associated identifier;
communicating the identifier associated with the client device to a configuration server that contains configuration information associated with the client device;
receiving the configuration information from the configuration server;
applying the configuration information to the client device; and
receiving video data from the configuration server.

2. A method as recited in claim 1 further comprising communicating the received video data to a display device.

3. A method as recited in claim 1 wherein the received data includes audio data.

4. A method as recited in claim 1 further comprising:
receiving a request to perform a task from a user of the client device;
requesting additional configuration information associated with the task from the configuration server;
receiving the additional configuration information from the configuration server; and
applying the additional configuration information to the client device.

5. A method as recited in claim 1 wherein the identifier is a unique identifier.

6. A method as recited in claim 1 wherein the client device is a set top box.

7. A method as recited in claim 1 wherein the client device is a display device.

8. A method as recited in claim 1 wherein the configuration information includes parental control settings to be implemented by the client device.

9. A method as recited in claim 1 wherein the configuration information includes a last channel tuned by the client device.

10. A method as recited in claim 1 further comprising discarding the configuration information after applying the configuration information to the client device.

11. A method as recited in claim 1 further comprising:
receiving changes to the configuration information;
applying the received changes to the client device; and
communicating the received changes to the configuration server.

12. A method as recited in claim 1 further comprising applying the configuration information to a second client device.

13. A method as recited in claim 1 further comprising:
accessing the configuration server that contains configuration information associated with the client device; and
changing the configuration information associated with the client device.

14. A method as recited in claim 13 wherein the changes to the configuration information are applied to the client device during subsequent initializations of the client device.

15. One or more computer-readable memories containing a computer program that is executable by a processor to perform the method recited in claim 1.

16. A method comprising:
receiving an identifier from a client device;
receiving a request for configuration information from the client device;
identifying the requested configuration information associated with the client device based on the received identifier;
communicating the requested configuration information to the client device; and
communicating video data to the client device for display on a display device.

17. A method as recited in claim 16 further comprising:
receiving a request for configuration information associated with the client device from another server; and
communicating the requested configuration information to the other server.

18. A method as recited in claim 16 further comprising receiving modified configuration information from the client device.

19. A method as recited in claim 18 further comprising storing the modified configuration information.

20. A method as recited in claim 18 further comprising communicating the modified configuration information to the client device during subsequent requests for configuration information from the client device.

21. One or more computer-readable memories containing a computer program that is executable by a processor to perform the method recited in claim 16.

22. One or more computer-readable media having stored thereon a computer program that, when executed by one or more processors, causes the one or more processors to:
receive a request to perform a task from a user;
determine configuration information needed to perform the requested task;
request the needed configuration information from a configuration server;
receive the needed configuration information from the configuration server;
apply the needed configuration information;
receive video data from the configuration server; and
communicate the received video data to a display device.

23. One or more computer-readable media as recited in claim 22 wherein the one or more processors further discard the needed configuration information after applying the needed configuration information.

24. One or more computer-readable media as recited in claim 22 wherein the needed information is applied to a plurality of client devices.

25. One or more computer-readable media as recited in claim 22 wherein the one or more processors further request the same configuration information in response to a subsequent request to perform the same task.

26. An apparatus comprising:
a storage device containing an identifier associated with the apparatus;
a communication interface; and
a processor coupled to the storage device and the communication interface,
wherein the processor is to communicate a request for configuration information and the identifier to a configuration server via the communication interface, wherein the processor is further to receive configuration information from a configuration server via the communication interface, and wherein the processor is to receive broadcast video data via the communication interface.

27. An apparatus as recited in claim 26 wherein the processor is further to process the received video data for display on a display device.

28. An apparatus as recited in claim 26 further comprising an audio/video output coupled to the processor and configured to communicate the received video data to a display device coupled to the audio/video output.

29. An apparatus as recited in claim 26 further comprising a tuner to tune at least one channel associated with the broadcast video data.
